(19) United States
(12) Patent Application Publication
(10) Pub. No.: US 2002/0035729 A1
(43) Pub. Date: Mar. 21, 2002

(54) Wireless cable system

(76) Inventor: Kha Diep, Atlantic City, NJ (US)

Correspondence Address: Matthew J. Peirce, Esq., 1550 Starlight Canyon Avenue, Las Vegas, NV, 89123, US

(21) Appl. No.: 09/960,182

(22) Filed: Sep. 20, 2001

Related U.S. Application Data
(60) Provisional application No. 60/233,902, filed on Sep. 20, 2000.

(51) Int. Cl. H04N 7/18

(52) U.S. Cl. 725/78; 725/80

(57) ABSTRACT

A new and improved wireless cable box system is disclosed that allows video to transmit from a main transmitter box to a plurality of receivers via a low band signal. A cable would be connected to the main transmitter box, and the box would subsequently transmit a low band (video and sound) to the receivers. The receivers are attached to the input of their specific television.

### I. BACKGROUND OF THE INVENTION

The present invention concerns that of a new and improved wireless cable box that allows video to transmit from a main box to receivers.

### II. DESCRIPTION OF THE PRIOR ART

U.S. Pat. No. 5,675,372, issued to Aguayo, Jr., et al., discloses a communications system which can be utilized to complement an existing cable television system in which a central office transmits signals along a coaxial cable to a user unit through a tap.

U.S. Pat. No. 5,329,370, issued to Yazolino et al., discloses a cable television system which provides television signals in multiple predefined television signal formats.

U.S. Pat. No. 4,916,532, issued to Streck et al., discloses a wireless local television transmission system with related methods, apparatus, and components.

### III. SUMMARY OF THE INVENTION

The present invention concerns that of a new and improved wireless cable box that allows video to transmit from a main box to receivers. A cable would be connected to the main transmitter box, and the box would subsequently transmit a low band (video and sound) to the receivers. The receivers are attached to the input of their specific television.

There has thus been outlined, rather broadly, the more important features of a wireless cable box in order that the detailed description thereof that follows may be better understood and in order that the present contribution to the art may be better appreciated. There are, of course, additional features of the wireless cable box that will be described hereinafter and which will form the subject matter of the claims appended hereto.

In this respect, before explaining at least one embodiment of the wireless cable box in detail, it is to be understood that the wireless cable box is not limited in its application to the details of construction and to the arrangements of the components set forth in the following description or illustrated in the drawings. The wireless cable box is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present wireless cable box. It is important, therefore, that the claims be regard as including such equivalent constructions insofar as they do not depart from the spirit and scope of the present invention.

It is therefore an object of the present invention to provide a wireless cable box which has all of the advantages of the prior art and none of the disadvantages.

It is another object of the present invention to provide a wireless cable box which may be easily and efficiently manufactured and marketed.

It is another object of the present invention to provide a wireless cable box which is of durable and reliable construction.

It is yet another object of the present invention to provide a wireless cable box which is economically affordable and available to the buying public.

It is yet another object of the present invention to provide a wireless cable box which provides additional benefits not present in the prior art.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a front view of the main transmitter box of the present invention.

FIG. 2 shows a front view of a receiver used with the present invention.

FIG. 3 shows a top view of a remote control that could be used with the present invention.

FIG. 4 shows a schematic of the whole system properly set up utilizing the transmitter, main receiver, and three secondary receivers.

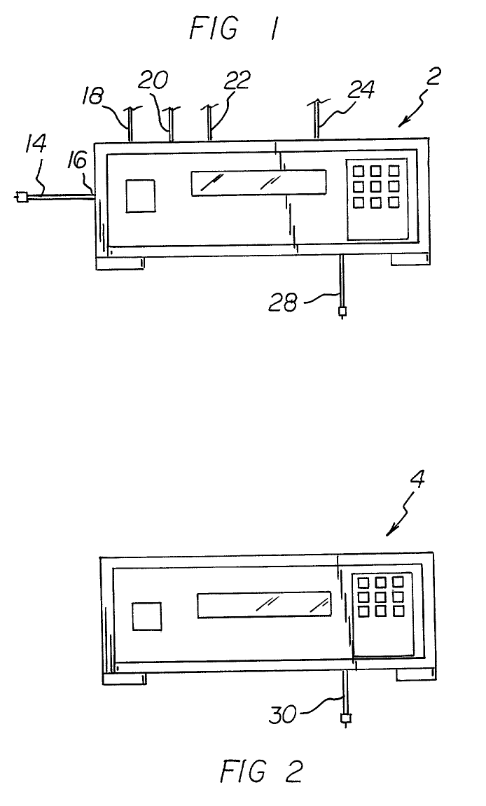

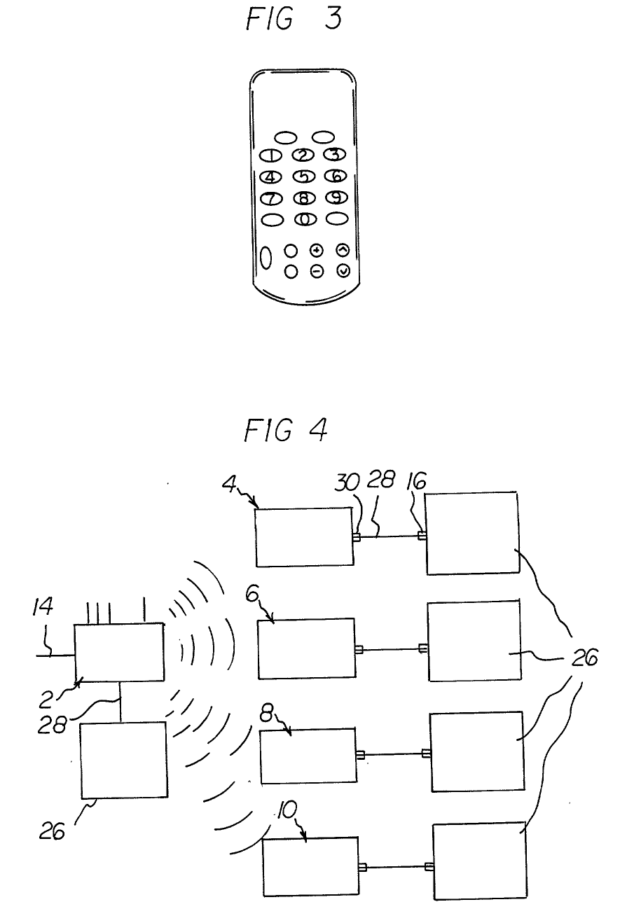

### V. DESCRIPTION OF THE PREFERRED EMBODIMENT

The present invention concerns that of a new and improved wireless cable system that allows video to transmit from a main transmitter box 2 to a plurality of receivers. The main transmitter box 2 would be hooked up to a television set or could be freestanding. The plurality of receivers would preferably comprise at least four receivers, designated receivers 4, 6, 8, and 10.

A cable 14 would be connected to the main transmitter box 2, which would have one coaxial cable input 16, three audio/visual (AV) inputs 18, 20, and 22, and one audio/video output 24 on the back of the transmitter box 2. The inputs 18, 20, and 22 would allow a user to hook up a VCR, DVD player, or other type of input that, when played, could both be viewed by a television hooked up to the main transmitter box 2 and have the signal transmitted to the receivers 4, 6, 8, and 10. The output 24 would be used by a television or stereo system and would be designed to play any input received from the coaxial cable input 16.

The transmitter box 2 would have the capability of doing an automatic channel screening to ensure that only channels that would be active in a particular area could be chosen by a user. Once the present invention would be in use, the main transmitter box 2 would subsequently transmit a low band signal, which would carry both audio and video, to each of the receivers.

Receivers 4, 6, 8, and 10 would be hooked up to various televisions 26 throughout a person's house. All the receivers would be programmed to receive the signal emitted by the main transmitter box 2, allowing whatever is being filtered through transmitter box 2 to be watched on one or more of the television sets hooked up to the receivers, if this is desired. When watching a television set hooked up to a receiver, a user would have the option of watching a normal television station or watching a signal being transmitted from the main transmitter box 2 to the particular receiver hooked up to the television set.

In addition, each receiver would have a self-timer and a sleep function. Both the self-timer and sleep function on each receiver could be controlled from the main transmitter box 2. Further, each receiver can be turned on and off from the transmitter box 2 and can be programmed to have a channel block, which would ensure children would only view appropriate programs.

The main transmitter box 2 would control all functions, except channel switching, for each receiver. The AV inputs 18, 20, and 22 on the transmitter would allow several users to each have the ability to watch their own programs. Further, the present invention would save a user money by not requiring them to purchase separate VCR and/or DVD players for each individual television set 26 throughout a particular house.

FIG. 4 shows a schematic of the whole system properly set up utilizing the transmitter 2, receivers 4, 6, 8, and 10. Each receiver is hooked up to a television 26 by cable 28. Cable 28 hooks up to a coaxial output 30 located on each receiver and a coaxial cable input 16 located on each television 26. This allows the signal picked up by each receiver to properly transmit to the associated television 26.

What I claim as my invention is:

1. A wireless cable system for transmitting audio and video signals within a residence comprising:
(a) a main transmitter box, the main transmitter box including at least one coaxial cable input, the main transmitter box further including at least three audio/visual inputs, the main transmitter box further including at least one audio/video output, the main transmitter box having an incorporated transmitter capable of transmitting audio and video signals via low band signal, the audio and video signals being received from an input source connected to the coaxial cable input,
(b) a plurality of receivers, each receivers designed to pick up the low band signal emitted by the main transmitter box, and
(c) a plurality of television sets, each television set being hooked up to a receiver, each television set capable of receiving both regularly available television stations and video and audio signals from the transmitter box.

2. A wireless cable system for transmitting audio and video signals within a residence according to claim 1 wherein the plurality of receivers would preferably comprise at least four receivers.

3. A wireless cable system for transmitting audio and video signals within a residence according to claim 1 in combination with a coaxial cable, the coaxial cable being connected to the coaxial cable input, the coaxial cable designed to carry cable television signals.

4. A wireless cable system for transmitting audio and video signals within a residence according to claim 3 wherein the main transmitter box would further include the capability to perform an automatic channel screening to exclude the possibility of an individual choosing a station not available in a particular geographic area.

5. A wireless cable system for transmitting audio and video signals within a residence according to claim 1 wherein each receiver would further include a self-timer and a sleep function, with the self-timer and sleep function on each receiver being controlled by the main transmitter box.

6. A wireless cable system for transmitting audio and video signals within a residence according to claim 1 wherein each television set hooked up to a receiver would be hooked up via a coaxial cable.
